(19) United States
(12) Patent Application Publication
(10) Pub. No.: US 2019/0141418 A1
(43) Pub. Date: May 9, 2019

(54) A SYSTEM AND METHOD FOR GENERATING ONE OR MORE STATEMENTS

(71) Applicant: KONINKLIJKE PHILIPS N.V., EINDHOVEN (NL)

(72) Inventors: Aki Sakari HARMA, Eindhoven (NL); Cliff Johannes Robert Hubertina LASCHET, Gulpen (NL); Marinus Bastiaan VAN LEEUWEN, Eindhoven (NL); Murtaza BULUT, Eindhoven (NL)

(21) Appl. No.: 16/092,008

(22) PCT Filed: Apr. 7, 2017
(86) PCT No.: PCT/EP2017/058409

§ 371 Date: Oct. 8, 2018

Related U.S. Application Data
(60) Provisional application No. 62/320,051, filed on Apr. 8, 2016.

(51) Int. Cl. H04Q 9/00; G06F 16/2457

(52) U.S. Cl. CPC H04Q 9/00; G06F 16/24578

(57) ABSTRACT

The present disclosure pertains to a method and system configured for generating one or more statements. In some embodiments, the system comprises at least one processor; memory operatively connected with the at least one processor; a communication component operatively connected to the at least one processor and configured to communicate with a user device via a network. The at least one processor is configure by machine-readable instructions to receive one or more measurements pertaining to a parameter of a user from the user device; generate one or more statements based on the one or more measurements and one or more templates; and transmit, via the network, the one or more statements for presentation on the user device.

### BACKGROUND

### 1. Field

The present disclosure pertains to a system and method for generating one or more statements.

### 2. Description of the Related Art

In the area of health and fitness self-management, a number of programs aim to coach people towards a healthier lifestyle based on a profile of a user including information such as body movements and activities, heart rate, weight, height, light and visual information, etc. Such information is collected from a wearable device, for example, Jawbone, Polar tracker, iWatch, smart watch, iPhone, smartphone, or any other on-body or on-clothing sensor devices. The programs developed for those devices employ one or more recommender systems to analyze the profile of the user, provide various types of coaching message to the user, or recommend one or more coaching resources to the user. However, existing programs provide only generic information that relates to observation of the user, for example, a daily activity summary as shown in FIG. 1(a), or a day-by-day comparison of the exercise records as shown in FIG. 1(b). Some programs provide insightful information to the user based on the medical profile and lifestyle behaviors of the user. For example, Jawbone provides insightful observations about the performance of the user, such as sleep and activities of the user. However, content provided by Jawbone is still based on a small set of generic statements which are often repeatedly used. As such, one or more statements provided to different users is similar.

Therefore, there is a need to provide an improved solution to provide the user with insightful and personalized statements about the behavior of the user based on long-term observation of data collected from the user devices.

### SUMMARY

Accordingly, one or more aspects of the present disclosure relate to a system for generating one or more statements. The system comprises at least one processor; memory operatively connected with the at least one processor; and a communication component operatively connected to the at least one processor and configured to communicate with a user device via a network. The at least one processor is configured by machine-readable instructions to receive one or more measurements pertaining to a parameter of the user from the user device; generate one or more statements based on the one or more measurements and one or more templates; and transmit, via the network, the one or more statements for presentation on the user device.

Yet another aspect of the present disclosure relates to a method implemented on a system for generating one or more statements. The system comprises at least one processor, memory, and a communication component. The method comprises receiving one or more measurements pertaining to a parameter of a user from the user device; generating one or more statements based on the one or more measurements and one or more templates; and transmitting, via the network, the one or more statements for presentation on the user device.

Still another aspect of the present disclosure relates to a system for generating one or more statements. The system comprises means for receiving, with at least one processor, one or more measurements pertaining to a parameter of a user from the user device; means for generating, with at least one processor, one or more statements based on the one or more measurements and one or more templates; and means for transmitting, with at least one processor, the one or more statements for presentation on the user device via a network.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an exemplary one or more statements presented to a user in prior art;

FIG. 2 illustrates an exemplary configuration of a system for generating one or more statements, in accordance with an embodiment of the present teaching;

FIG. 3 illustrates an exemplary configuration of a system for generating one or more statements, in accordance with another embodiment of the present teaching;

FIG. 4 illustrates an example of basic building blocks for generating one or more statements, in accordance with an embodiment of the present teaching;

FIG. 5 illustrates an exemplary statement family with one or more templates, in accordance with an embodiment of the present teaching;

FIG. 6 illustrates an exemplary statement family with one or more statements, in accordance with an embodiment of the present teaching;

FIG. 7 illustrates exemplary statements and corresponding content texts, in accordance with an embodiment of the present teaching;

FIG. 8 illustrates an exemplary flowchart for generating one or more statements, in accordance with an embodiment of the present teaching; an

FIG. 9 illustrates an exemplary flowchart for building the templates for generating one or more statements, in accordance with an embodiment of the present teaching.

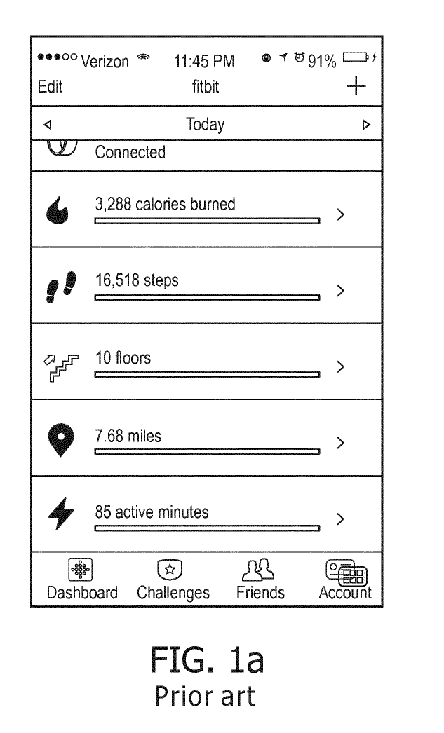

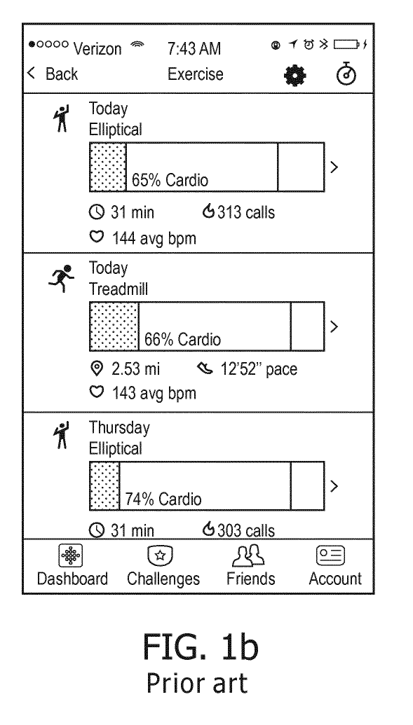

### DETAILED DESCRIPTION OF EXEMPLARY EMBODIMENTS

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present teaching describes an automatic discovery of information from data associated with a user, and presentations of one or more statements to the user conveying such information. The one or more statements according to the present teaching are configured to convey information related to a plausible observation directed to the behavior of the user. The one or more statements according to the present teaching may be further configured to convey health-related information of the user. The one or more statements may be presented as a fact that the user already recognizes. Further, the one or more statements may be presented as a revealing of a hidden behavior pattern with advice to the user to change behavior to a better direction. The present teaching describes a system and method for automatically generating a large number of one or more statements candidates that are meaningful in a particular program context, computing for each of the one or more statements, a score based on statistical and heuristic weighting rules, and presenting the one or more statements that has high scores to the user.

According to the present teaching, one or more statements is generated based on dynamic data collected from a program implemented on a wearable device as well as long-term observations of a large population of users. The program according to the present teaching is an application designed to be implemented on a mobile device to monitor physiological or psychological signs of the user as well as to track the real-time activities of the user. The program according to the present teaching may be a health-related program or a health-related application. The programs developed for those devices employ one or more recommender systems to analyze the profile of the user, provide various types of message to the user, or recommend one or more resources to the user. The one or more statements comprise one or more personalized insights of the health-related behavior of the user. The one or more statements may be presented as one or more texts displayed or played on the wearable device, one or more graphical illustrations displayed on the wearable device, a content card comprising one or more texts displayed on the wearable device, a content card comprising integrated texts and graphical illustrations displayed on the wearable device, or any combinations thereof. In some embodiments, content card plays a major role in providing one or more statements to the user. Content card may be generated with respect to different objectives, for example, education, feedback on performance, insight, motivation, etc. An insight card provides valuable feedback and inspiration to the user, and helps the user to choose new opportunities to form healthier behavior and habits. Accordingly, the present teaching can provide to the user, insightful information that is personalized for each individual user and has more impact on the behavior of the user.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

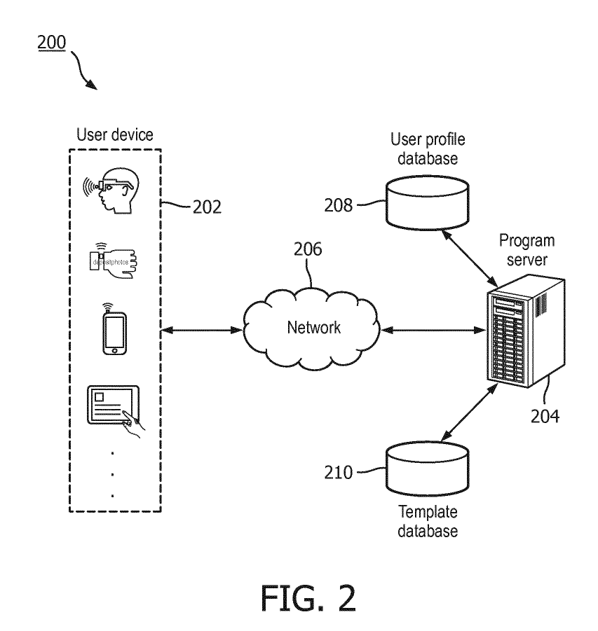

FIG. 2 illustrates an exemplary configuration of a system 200 for generating one or more statements, in accordance with an embodiment of the present teaching. The system comprises one or more user devices 202, a program server 204, a network 206, a user profile database 208, and a template database 210.

User device 202 may include one or more mobile devices implemented with a program to monitor the physiological or psychological signs and track the real-time activities of the user. User device 202 may be a mobile device wearable on an arm with or without accessory, for example, Jawbone, Polar tracker, iWatch, smart watch, iPhone, smartphone. In some embodiments, user device 202 may be heads-up display smart glasses such as, google glasses, Microsoft hololens, etc. User device 202 is configured to communicate with a program backend server such as program server 204 via network 206. User device 202 may also communicate with program server 204 via a desktop, a laptop, or a tablet computer. In some embodiments, user device 202 may be configured to communicate with other devices associated with the same user such that the information individually stored therein is synchronized. In some other embodiments, user devices 202 may be configured to communicate with other devices associated with different users such that information individually collected with respect to the different users can be shared. The examples described above are for illustrative purpose only. The present teaching is not intended to be limiting. User device 202 may include any other on-body sensor devices, on-clothing sensor devices, or implanted sensor devices.

Program server 204 is configured to be a backend server for the program. Program server 204 receives data collected via one or more user devices 202, stores the received data in user profile database 208, and generates one or more statements conveying one or more statements to the user. Program server 204 is programmed to handle the operations of the program implemented on the one or more user devices 202 via network 206. For example, program server 204 processes user registration request, user device activation request, user information updating request, data uploading request, data synchronization request, etc. The data received at program server 204 may be a plurality of measurements pertaining to the parameters, for example, body movements and activities, heart rate, respiration rate, blood pressure, body temperature, light and visual information, etc. Based on the data observed during a period of time and/or over a large population of users, program server 204 generates one or more statements pertaining to each specific parameter, and provides the one or more statements via network 206 for presentation on user device 202. In some embodiments, program server 204 is configured to a backend server for a health-related program or a health-related application implemented on the mobile device. The functions of program server 204 described above are for illustrative purpose only. The present teaching is not intended to be limiting. Program server 204 may be a general computing server or a dedicated computing server. Program server 204 may be configured to provide backend support for the program developed by a specific manufacturer. However, program server 204 may also be configured to be interoperable across other servers, and generate the statement in a format that is compatible with other programs.

User profile database 208 is configured to store user profile data including the real-time measurements of the parameters for a large population of users, personal information of the large population of users, previously generated statements related to the large population of users, etc. In some embodiments, user profile database 208 is configured to store health-related information of the user. User profile data is organized to model various aspects of a user in a way that supports simple querying as well as complicate data analysis. User profile database 208 may be a backend database of program server 204, as illustrated in FIG. 2. In some embodiments however, user profile database 208 may be network storage and/or cloud storage directly connected to network 206. In other embodiments, user profile database 208 may serve as backend storage of program server 204 as well as network storage and/or cloud storage. User profile database 208 is updated periodically and/or in response to a request from user device 202 and/or program server 204.

Template database 210 is configured to store one or more templates that are used to generate the statements conveying information to the user. Statements for different objectives may use different templates. For example, education related statements may apply templates with referral links to educational resources; feedback on performance may apply templates with rating/ranking comments, etc. Template database 210 may be maintained by an administrator operating program server 204. Template database 210 may be updated based on the usage of each template, the feedback on each generated statement, etc. Templates that are more often used and/or receive more positive feedbacks from the users may be highly recommended to generate the statements in the future. In some embodiments, the templates may be general templates that can be used to generate all types of statements. In some other embodiments, the templates may be classified into categories, each category pertaining to a parameter. For example, templates for generating statement pertaining to heart rate may be partially different from templates for generating statement pertaining to sleep quality.

Network 206 is configured to transmit information among a plurality of components connected to the network. For example, network 206 transmits data collected at user device 202 to program server 204, and the statements conveying one or more statements for presentation on user device 202. Network 206 may be a single network or a combination of multiple networks. For example, network 206 may be a local area network (LAN), a wide area network (WAN), a public network, a private network, a proprietary network, a Public Telephone Switched Network (PSTN), the Internet, a wireless communication network, a virtual network, and/or any combination thereof.

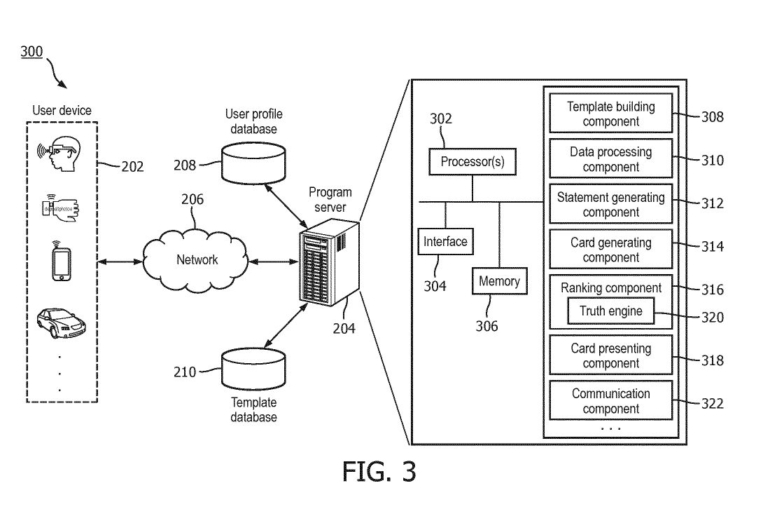

FIG. 3 illustrates an exemplary configuration of a system 300 for generating one or more statements, in accordance with an embodiment of the present teaching. Program server 204 illustrated in FIG. 2 comprises processor(s) 302, an interface 304, memory 306, a template building component 308, a data processing component 310, a statement generating component 312, a card generating component 314, a ranking component 316, a card presenting component 318, and a communication component 322.

Processor(s) 302 is operatively communicated with interface 304 and memory 306. Processor(s) 302 may include one or more of a digital processor(s), analog processor(s), a digital circuit designed to process information, an analog circuit designed to process information, a state machine, a transmitter, a receiver, and/or other mechanism(s) or processor(s) for electronically processing information. Although processor(s) 302 is shown in FIG. 3 as a single entity, this is for illustrative purposes only. In some embodiments, processor(s) 302 may include one or more processing units. The one or more processing units may be physically located within a same device. Further, processor(s) 302 may be configured to execute one or more computer program components including template building component 308, data processing component 310, statement generating component 312, card generating component 314, ranking component 316, card presenting component 318, and communication component 322. Processor(s) 302 may be configured to execute components 308, 310, 312, 314, 316, 318 and 322 by software; hardware; firmware; some combination of software, hardware, and/or firmware; and/or other mechanisms for configuring processing capabilities on processor(s) 302.

Each of the one or more computer programmed components comprises a set of algorithms implemented on processor(s) 302 that instructs processor(s) 302 to perform one or more functions related to generating the statements, and/or other operations. For example, template building component 308 comprises algorithms implemented on processor(s) 302 that instruct processor(s) 302 to build one or more templates for generating the statements; data processing component 310 comprises algorithms implemented on processor(s) 302 that instruct processor(s) 302 to analyze the received data at interface 304; statement generating component 312 comprises algorithms implemented on processor(s) 302 that instruct processor(s) 302 to generate one or more statements pertaining to a parameter; card generating component 314 comprises algorithms implemented on processor(s) 302 that instruct processor(s) 302 to generate a content card comprising the one or more statements pertaining to a parameter; card presenting component 318 comprises algorithms implemented on processor(s) 302 that instruct processor(s) 302 to present the generated content card to the user; and communication component 322 comprises algorithms implemented on processor(s) 302 that instruct processor(s) 302 to perform communications within one or more components of processor(s) 302, and between processor(s) 302 and other components of the system and/or other network components.

It should be appreciated that although components 308, 310, 312, 314, 316, 318 and 322 are illustrated in FIG. 3 as being co-located with a single processing unit, in implementations in which processor(s) 302 includes multiple processing units, one or more of these components may be located remotely from the other components. The description of the functions provided by the different components 308, 310, 312, 314, 316, 318 and 322 described below is for illustrative purposes, and is not intended to be limiting, as any of components 308, 310, 312, 314, 316, 318 and 322 may provide more or less functions than is described. For example, one or more of components 308, 310, 312, 314, 316, 318 and 322 may be eliminated, and some or all of its functions may be provided by other ones of components 308, 310, 312, 314, 316, 318 and 322. As another example, processor(s) 302 may be configured to execute one or more additional components that may perform some or all of the functions attributed below to one of components 308, 310, 312, 314, 316, 318 and 322.

User interface 304 is configured to provide an interface between program server 204 and user device 202. Data transmitted via network 206 is received at interface 304. If the received data comprises a request from the user to receive a report of the past week sleep quality, processor(s) 302 instructs data processing component 310 to process the request from the user and provide one or more statements pertaining the sleep quality of the user in the past week. In another embodiment, user interface 304 is configured to provide an interface between an administrator and program server 204. The administrator may input the request via user interface 304 to manage template database 210. Upon receiving the request, processor(s) 302 instructs template building component 308 to process the request and provide information via interface 304 to enable the administrator to create, modify, and/or delete the templates. In some embodiments, user interface 304 may be a computer programmed component implemented on program server 204 and configured to automatically monitor incoming data from network 206. In some other embodiments, user interface 304 may include one or more exterior devices such as, a keypad, buttons, switches, a keyboard, knobs, levers, a display screen, a touch screen, speakers, a microphone, a printer, and/or other interface devices. In some embodiments, user interface 304 may include a plurality of separate interfaces, and/or a combination of the interfaces set forth above.

Memory 306 is configured to electronically stores information in an electronic storage media. Memory 306 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. The electronic storage media of memory 306 may comprise one or both of system storage that is provided integrally (i.e., substantially non-removable) with the system and/or removable storage that is removably connectable to the system via, for example, a port (e.g., a USB port, a firewire port, etc.) or a drive (e.g., a disk drive, etc.). Memory 306 stores computer programs to be executed via a plurality of components 308, 310, 312, 314 and 316. In addition, memory 306 stores data received from user device, templates created and/or modified, and the generated statements. In some embodiments, information saved in memory 306 is further uploaded to user profile database 208 and template database 310, respectively.

As used herein, the term “statement” is defined as health-related information of an individual. In one or more embodiments, a statement may comprise one or more of the following: (a) a first comparison description of the one or more measurements between two objects in a temporal space; (b) a second comparison description of the one or more measurements between two objects in a user space; (c) an extrema description of the one or more measurements; (d) an interaction description of the one or more measurement; or (e) a trend description of the one or more measurements. The temporal space relates to a time period during which the measurements of parameters of the individuals are collected. The temporal space comprises one or more objects, each corresponding to a time interval, for example, “Monday” corresponding to a 24-hour long time interval, “morning” corresponding to a segment of a 24-hour long time interval, “work day” corresponding to a combination of the 24-hour long time intervals, “at work” corresponding to a combination of the segments of the 24-hour long time intervals, etc. The user space relates to one or more groups of individuals from which the measurements of parameters of the individuals are collected. The user space comprises one or more objects, each corresponding to a group of individuals, for example, “women in 30's,” “legal professionals,” “high school students,” etc. The extrema description describes one or more extreme observations across the temporal space and/or the user space based on the one or more measurements, for example, “a best running performance is achieved on the afternoon of Thursday.” The interaction description describes correlations between the one or more measurements across the temporal space and/or the user space, for example, “After workday, your active minutes are higher than your daily average.” The trend description describes the measurement trends observed across the temporal space and/or the user space, for example, “Today, your exercise duration is longer than any day in the last week.”

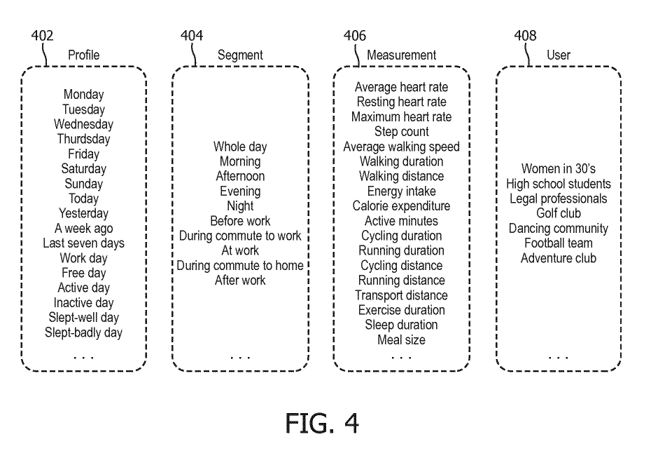

Template building component 308 is configured to build a set of templates that can be applied to generate the statements. Template building component 308 defines one or more building blocks and explores all possible combinations between the one or more building blocks. Referring to FIG. 4, the one or more building blocks include a profile block 402 pertaining to long time intervals, a segment block 404 pertaining to short time intervals, a measurement block 406 pertaining to the measurement models, and a user block 408 pertaining to user groups. Profile block 402 defines one or more 24-hour time intervals such as, Monday, Tuesday, today, yesterday, a week ago, etc. In some embodiments, profile block 402 defines one or more combinations of the 24-hour long time intervals based on information related to an individual. For example, profile block 402 defines “work day” as Monday through Friday, “slept-well day” as the days when the individual's sleep quality is above a threshold, etc. Segment block 404 defines one or more segments of a 24-hour time intervals, for example, morning, before work, during commute to work. Measurement block 406 defines one or more measurement models pertaining to parameters. The parameters may indicate at least one of physiological or psychological signs of the user or physical activities of the user such as heart rate, respiration rate, running, cycling, etc. In some embodiments, for the parameter of heart rate, three measurement models are defined as average heart rate, resting heart rate, and maximum heart rate. In another embodiment, for the parameter of walking, four measurement models are defined as step count, average walking speed, walking duration, and walking distance. User block 408 defines one or more user groups. In some embodiments, the user groups may be defined based on locale information, age information, professional information, social networking information, etc.

It should be appreciated that the examples of profile block 402, segment block 404, measurement block 406, and user block 408 as illustrated in FIG. 4 are for illustrative purpose only. The present teaching is not intended to be limiting. As the program is intended to provide the users with accurate and comprehensive assessment of their health conditions, template building component 308 may define any length of time intervals to be included in profile block 402 and segment block 404. Template building component 308 may further define more measurement models and refine user groups such that more detailed information can be conveyed to the users. It should also be appreciated that template building component 308 may define additional building blocks to be applied to generate the statements. In some embodiments, template building component 308 may define one or more additional profiles pertaining to an object, where the object may include a location, a particular type of device, a friend of the user, a community that the user belongs to, eating behavior, dressing behavior, etc. For example, locale-based building block may be applied to provide users with performance assessments on different geographic locations, i.e., user's marathon performance may vary in Washington D.C. vs. in Phoenix, Ariz. In yet another example, the one or more additional profiles may indicate that the user wears Nike shoes longer than wearing Versace shoes in a day. In yet another example, the one or more additional profiles may indicate that the user had a hamburger yesterday for lunch while had a cup of soap for lunch today. It should be appreciated that the above examples are for illustrative purpose only, and the present teaching is not intended to be limiting.

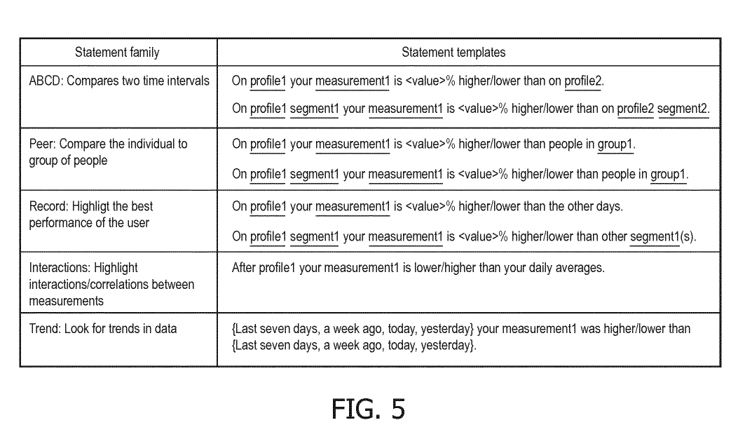

Given the pre-defined building blocks, template building component 308 explores all possible combinations between the pre-defined building blocks. Template building component 308 further refines the all possible combinations based on certain criteria, for example, to exclude combinations that compare Mondays to Mondays, etc. In some embodiments, template building component 308 may build a set of general templates that can be applied for all parameters. In some other embodiments, template building component 308 may build an individual set of templates to generate statements pertaining to a specific parameter. Referring to FIG. 5, a plurality of templates 502 is built with respect to “measurement 1.” The plurality of templates 502 may be classified into five categories 504: (a) a category that compares one or more values related to “measurement 1” in two time intervals; (b) a category that compares an individual to a user group; (c) a category that highlights the best performance of the individual; (d) a category that highlights interactions and/or correlations between multiple values of “measurement 1;” and (e) a category that observes the trend in “measurement 1.” It should be appreciated that the templates and the categories of templates are for illustration purpose only. The present teaching is not intended to be limiting. Other criteria such as locale information may be applied to classify the plurality of templates. In some embodiments, users of the program such as a coach may also define the plurality of templates.

Data processing component 310 is configured to process the data received via interface 304 so that reliable measurements are used to generate the statements. Data received via interface 304 are information collected from one or more sensors implemented on the one or more user devices 202. Data collected from the one or more sensors may comprise all types of noise signals from the surrounding environment and/or from other sources that affect the accuracy of measurements. For example, a noise signal may magnify a measurement of heart rate to an unreasonable level and cause an erroneous measurement. In another example, noise signals may cause the loss of measurements that are continuously collected in real-time. Data processing component 310 may detect and correct the erroneous measurements, and recover the missing measurements based on one or more digital signal processing algorithms such that reliable measurements are provided to generate the statements.

In some embodiments, data processing component 310 computes representations of daily exercise measurement data, for example, average values of the measurements in different daily segments. Data processing component 310 divides a day into semantically meaningful segments that can be referred to in the statements. Exemplary segments may comprise the time period during which the user is commuting to work, the time period during which the user is at work, or the time period during which the user is in a fitness club, etc.

In some embodiments, the temporal segmentation is determined based on the location change of the user during the day. Location data may originate from a global positioning system (GPS), terrestrial radio frequency (RF) sources such as Wi-Fi, GSM, or near field communication (NFC), etc. Location data may comprise global coordinates of locations and/or names of the places. Location data is collected via one or more application implemented on the user devices 202, for example, Moves app. Moves app produces two types of location data. The first type of location data contains a list of locations where the user has stopped for one minute or more. These places get a unique ID and additional attributes such as semantic information, address, and visit counts. The second type of location data contains data points collected over a movement trajectory during an activity. Activity may be cycling, walking trip, transport which typically starts from one place and ends in another (or the same) place. The second type of location data has no attributes, but the entire activity may have a classification based on transportation modality, step counts, and other measures. The present teaching classifies the location data into four groups including home, work, other places, K-places (which denote intermediate places during commuting) based on one or more heuristic rules. For example, the heuristic rules may include (a) the place where the user spends the night is home; (b) the place where the user is in weekdays between 10 am and 3 pm for more than 2 hours is work; (c) the places where the users stops between home and work is K-place. It should be appreciated that the examples described above are for illustrative purpose, and the present teaching is not intended to be limiting. The temporal segmentation may be based on blind segmentation and the classification of locations may be based on the measurements and additional user metadata. In some embodiments, additional user metadata may be collected via interviewing, user input from a graphical user interface, answers on questionnaire, and/or other methods. In some embodiments, the classification of locations and the consequent segmentation of time period may be trained using machine learning algorithm over a large population of data.

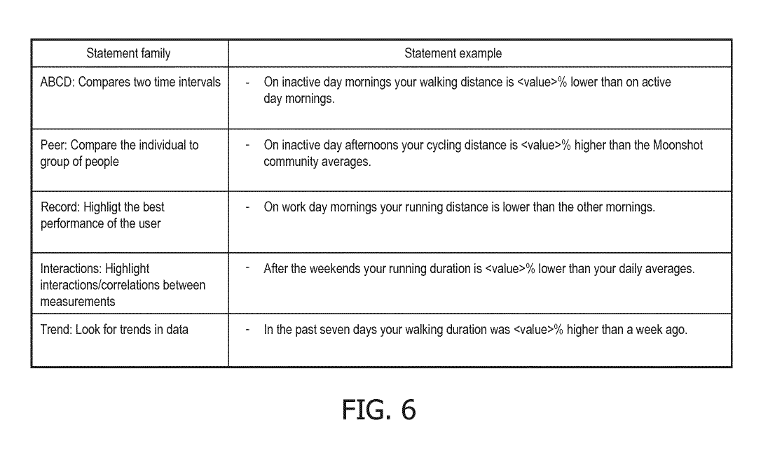

Statement generating component 312 is configured to generate one or more statements based on the measurements of parameters and the templates. In some embodiments, the measurements that are collected in real-time over a time period are further processed to generate an augmented measurement sets. For example, measurements of a user's heart rate over one month comprise a large amount of individual measurements. An augmented measurement sets may be generated to include an average heart rate over the one month, an average heart rate during sleep, a percentage of times when the heart rate exceeds 130, etc. FIG. 6 illustrates an example of the generated statements based on the templates shown in FIG. 5. With respect to the parameter “walking,” two statements are generated as “On inactive day mornings, your walking distance is <value>% lower than on active day mornings;” and “In the past seven day, your walking duration was <value>% higher than a week ago.” Contrast to existing programs where a statement may simply summarize the walking distance in a daily and/or weekly basis, the present teaching provides the statements with a comparison observation and a trend observation based on the large amount of measurements. The statements therefore, provide analytical assessments on the user's walking performance, and help the user to better capture the improvement by continue walking. It should be appreciated that the statements and the categories of statements in FIG. 6 are for illustration purpose only. The present teaching is not intended to be limiting. All combinations of the profile block 402, segment block 404, measurement block 406, and user block 408 shown in FIG. 4 can be applied to generate a statement.

Card generating component 314 is configured to format the one or more generated statements in a content card for presentation on user device 202. As used herein, a content card generated for a specific parameter defines a “family” of statements associated with the specific parameter. For example, the content card generated for sleep quality defines a family of statements related to sleep quality, while the content card generated for running defines a family of statements related to running. The content card may be configured to present a certain number of statements within the card. Different families may define different numbers of statements for presentation. In some embodiments, the content card may be configured to present the statements related to the feedback of an activity performance. In some other embodiments, the content card may be configured to present the statements comprising educational information. In yet some other embodiments, the content card may be configured to present the statements comprising insightful analysis of the user's health-related conditions. In some embodiments, the content card may comprise only text statements. In some other embodiments, the content card may comprise content in multiple formats including but not limited to text, audio, video, flash, hyperlink to other sources, etc. It should be appreciated that the content card may be generated for purposes other than the examples described above, and the format of the content card may be adjustable for presentation on different user devices. The examples set forth above are for illustrative purposes; and the present teaching is not intended to be limiting.

Due to the large amount of available templates, the number of generated statements may be large. Even though individual family may set a number of statements for presentation, the level of meaningfulness of the statements varies in accordance with the templates. For example, a statement of “In the past seven days, your walking duration was 20% higher than a week ago” is more meaningful than a statement of “On inactive day mornings, your walking distance is 30% lower than on active day mornings.” Presenting the number of statements based on the levels of meaningfulness helps the user to learn useful information more efficiently. Ranking component 316 is configured to compute a score via a truth engine 320 for each generated statement and rank all generated statements based on the scores. In some embodiments, the score of a statement indicates a level of truthfulness of the statement. The higher the score, the more accurate and/or insightful the information is conveyed via the statement. In another embodiment, the score of a statement indicates a level of interesting or useful of the statement to the user. The higher the score, the more interesting or more helpful the statement that the user considers. In some embodiments, the score is computed using a same configuration of algorithms and/or parameters for all generated statements. In some other embodiments, the score is computed differently for different families.

Many statements contain a number x which may represent an absolute measurement value, a difference between values, or a computed value using truth engine 320. In some circumstances, the number x may appear incorrect in a statement. For example, the number x refers to tiny step counts or distances in a statement or the number x refers to calorie burn 99% less than a typical user when doing a same exercise. Most of the incorrect measurements are due to the errors during sensing or missing information during transmission from the user device to the program server. To eliminate the odd statements with erroneous measurements, truth engine 320 defines a range [x_{bot,m}, x_{ceil,m}] for the number x such that measurement value falls outside the range is filtered out for presentation.

The score is computed based on statistical significance with four factors implemented therein. The four factors comprise:

(1) Statistical significance of the difference based on the distributions and values D_{ab};

(2) Weight based on the number of occurrences of the referred context (i.e., element in profile block 402, segment block 404, measurement block 406, and user block 408) W;

(3) Quality of data which contains the amount of missing data and measurement errors Q;

(4) Custom weighting for each family U_{f}.

To compute the statistical significance, a difference between two scalar measurement values xₐ and x_{b}, two probability density functions fₐ (x) and f_{b} (x), or the combinations thereof may be implemented to represent a divergence value. In some embodiments, Hellinger divergence measure is used to compare two probability density functions. The Hellinger divergence measures the squared difference between squared roots of the distributions as the divergence value:

$$\begin{matrix}{H}_{ab}^{2} = \frac{1}{2} \int {( \sqrt{{f}_{a} ( x )} - \sqrt{{f}_{b} ( x )} )}^{2} dx \\ = \frac{1}{2} \int {f}_{a} ( x ) + {f}_{b} ( x ) dx - \int \sqrt{{f}_{a} ( x ) {f}_{b} ( x )} dx \\ = 1 - \int \sqrt{{f}_{a} ( x ) {f}_{b} ( x )} dx\end{matrix}$$

In an embodiment where xₐ and x_{b} are discrete distributions, the divergence value H_{ab}² corresponds to Euclidean distance between the two discrete distributions.

In another embodiment where xₐ and x_{b} are normal distributions N(μ, σ), the squared Hellinger divergence measure H_{ab}² is computed as:

$${P}_{ab} = \vert {H}_{ab}^{2} = 1 - \sqrt{\frac{2 {σ}_{a} {σ}_{b}}{{σ}_{a}^{2} + {σ}_{b}^{2}}} {e}^{- \frac{{( {μ}_{a} - {μ}_{b} )}^{⋀} 2}{4 ( {σ}_{a}^{2} + {σ}_{b}^{2} )}}$$

The divergence value falls in a range of [0, 1]. If two distributions are identical, the divergence value is 0 and if two distributions are non-overlapping, the divergence value is 1.

In another embodiment where a scalar measurement is compared to a distribution, the divergence value is obtained directly from the distribution function evaluated at the given measurement data point. If the distribution is a normal distribution N(μ, σ), the divergence value is computed as:

$${V}_{ab} = 1 - {e}^{- \frac{{( x - {μ}_{a} )}^{2}}{2 {σ}_{a}^{2}}}$$

In another embodiment where the comparison is performed between two scalar measurement values xₐ and x_{b}, the divergence value is computed as:

$${M}_{ab} = 1 - \frac{2}{1 + exp \frac{{( {x}_{a} - {x}_{b} )}^{2}}{{d}_{m}}}$$

where dₘ is determined based on the pre-defined range [x_{bot,m}, x_{ceil,m}], i.e., dₘ=x_{ceil,m}−x_{bot,m}.

The statistical significance D_{ab} may be represented as:

$${D}_{ab} = \{ \begin{matrix}{P}_{ab} , & if both objects are distributions \\ {V}_{ab} , & if one object is a distribution \\ {M}_{ab} , & if both objects are scalars\end{matrix}$$

As the measurement distributions do not contain a number of occurrences of the object, an additional weighting may be applied. When the smallest count of the object occurrences in a given object pair is c, the weight term is computed as:

$${W}_{k} = 1 - {e}^{- \frac{c}{α}} \text{/} β$$

where typical parameters are α=3, β=2.

The data quality Q is a scalar value in the range of [0, 1] indicative of the percentage of complete and correct measurements.

In some embodiments, each family may have a priori weight U_{f} applied to all the statements in the family. In another embodiment, each individual statement may have a specific priori weight.

The score is computed as a product of the individual four factors shown as:

Sₖ=D_{ab}WQU_{f}

Ranking component 316 is further configured to sort the statements in a family based their computed scores in a descending order. It should be appreciated that the score computation described above is for illustrative purpose. Other factors may also be considered to compute the score of a statement. For example, the user's feedback on a specific type of statement may indicate the popularity of the specific type of statement, and thus, may influence the score of the statement. Other factors such as financial aspects may also affect the score of a statement. In some embodiments, one or more combinations of the factors may also be considered as a weighted factor for computing the score of a statement. The computation of statistical significance D_{ab} set forth above is employed to those families where the statements highlight a difference in context such that a higher score is obtained if the measurements are different. In some other embodiments where the contexts are similar and a low score is obtained if the measurements are different, for example, “You are equally active on Mondays and Tuesdays,” the statistical significance D_{ab} is replaced by 1−D_{ab} for the ranking purpose. In some other embodiments, alternative divergence measures may also be used to compare two probability density functions such as, Kolmogorov-Smirnov test, Kullback-Leibler measure, or the χ-squared (i.e., Pearson) divergence measure. Therefore, the present teaching is not intended to be limiting.

Card presenting component 318 is configured to receive the ranked statements in a content card format and present the content card to the user. Card presenting component 318 may prepare the presentation of the content card based on the settings pre-defined by the user and/or the configuration of each individual user device. The settings pre-defined by the user may comprise how the user wants to be notified with the content card, for example, in a text format, in a chart format, in an audio format with low-tone female voice, in a video/flash format, and/or the combinations thereof. The settings pre-defined by the user may further comprise when and how often the user wants to be notified with the content card, for example, every evening around 9:00 pm, every afternoon after exercise, every week, every month, and/or the combination thereof. The settings pre-defined by the user may further comprise a preferred user device to receive the content card if the user has multiple devices. The configuration of each individual user device may include the size and resolution of the display screen of a user device, the caching space of the user device, etc. In some embodiment, card presenting component 318 may determine the connection status of the user device before sending the content card. If the user device is determined unavailable due to power off, offline, damaged, etc., card presenting component 318 may store the generated content card in memory 306 and/or upload the generated content card to user profile database 208. Once the user is detected logged-in using one of his/her user devices, the generated content card is transmitted to the user device for presentation. In some embodiments, if the preferred user device is unavailable, card presenting component 318 adjusts the content card for presentation in the logged-in user device.

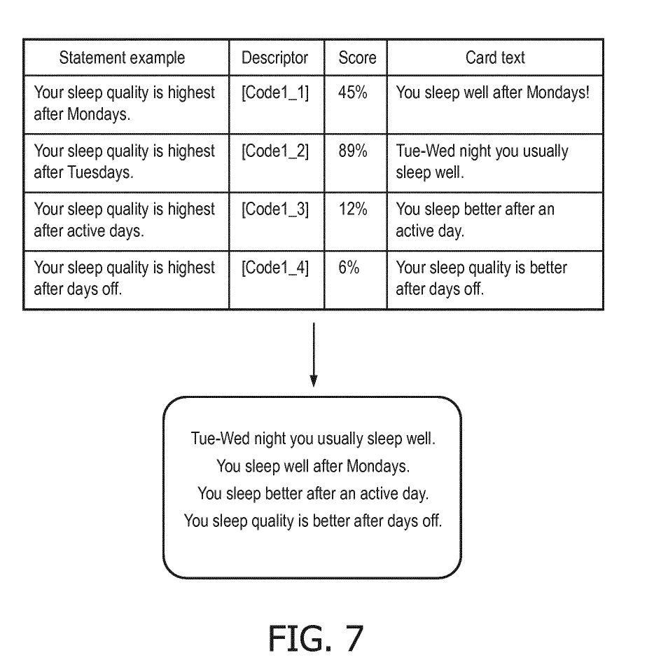

In some embodiments, card presenting component 318 may convert a statement to one or more variations of the statement so that the converted statement matches a desired tone of voice, target population, or language, etc. The variations of a word and/or a statement may be acquired from a linguistic knowledge base. Referring to FIG. 7, the exemplary statements are converted into content texts for presentation. For example, statement “Your sleep quality is highest after Mondays” may be converted to “You sleep well after Mondays.” In addition, the converted statements are presented in a descending order based on the computed scores in a content card.

In some embodiments, card presenting component 318 may generate a large number of visual representations of a human body. The measurement data based on body sensors may be used to determine one or more images that mostly measurement data. The one or more images are further included in the content card for presentation. Therefore, the content card presents a health picture of the individual, which can also be forwarded to a caregiver for reference. In some embodiments, the content card may be presented in an orchestral arrangement of a melody played back to the user.

It should be appreciated that the examples of card presentation described above are for illustrative purpose. The present teaching is not intended to be limiting. In some embodiments, card presenting component 318 may supplement additional information to the statements for presentation of the content card. The additional information comprises professional advices on how to improve the user's health condition, feedbacks from a community environment, educational resources, etc.

Communication component 322 is configured to perform communications between processor(s) 302 and other components of program server 204. In some embodiments, communication component 322 communicates with user devices 202 periodically to acquire the information related to the user and/or the user's activities, and to transmit the one or more statements for presentation on the user devices 202. In some embodiments, communication component 322 communicates with user devices 202 to update the application implemented on the user devices. In another embodiment, communication component 322 communicates with user profile database 208 to obtain personal information of the user, the measurements related to physiological or psychological signs of the user, the measurements related to activities of the user, previously generated statements and/or content cards for the user, etc. Communication component 322 also communicates with user profile database 208 to upload newly generated statements and/or content cards. In yet another embodiment, communication component 322 communicates with template database 210 to obtain pre-built templates for generating the statements; store newly created and/or modified templates; or delete templates from template database 210. Communication component 322 is a physical component implemented on the computer, for example, a network interface controller (also known as a network interface card, network adapter, network interface, etc.). Communication component 322 may be a special expansion card plugged into a computer bus and operatively connected to processor(s) 302. In some embodiment, communication component 322 implements an electronic circuitry required to communicate with the network using a specific physical layer and data link layer standard such as Ethernet, Fiber Channel, Wi-Fi or Token Ring. This provides a base for a full network protocol stack, allowing communication among small groups of computers on the same local area network (LAN) and large-scale network communications through routable protocols, such as Internet Protocol (IP). Communication component 322 may be both a physical layer and data link layer device because it provides physical access to a networking medium and a low-level addressing system for IEEE 802 and similar networks through the use of media access control (MAC) addresses that are uniquely assigned to network interfaces. The present teaching contemplates any techniques for communication including but not limited to hard-wired and wireless communications.

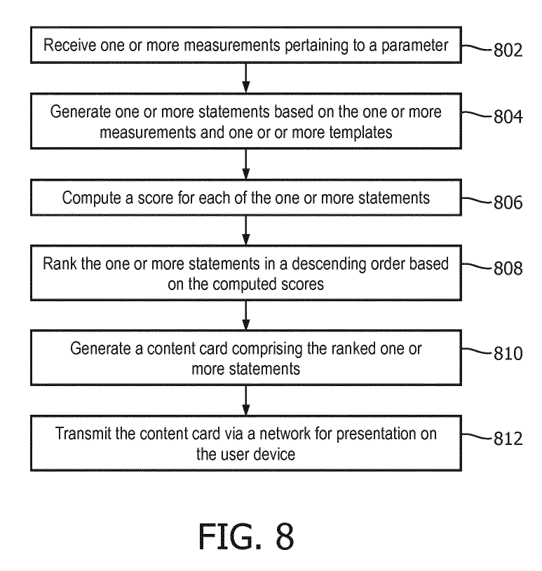

FIG. 8 illustrates an exemplary flowchart for generating one or more statements, in accordance with an embodiment of the present teaching. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 8 and described below is not intended to be limiting.

At operation 802, one or more measurements pertaining to a parameter are received. In some embodiments, operation 802 is performed by an interface and/or data processing component the same as or similar to interface 304 and/or data processing component 310 (shown in FIG. 3 and described herein).

At operation 804, one or more statements are generated based on the one or more measurements and one or more templates. In some embodiments, operation 804 is performed by a statement generating component the same as or similar to statement generating component 312 (shown in FIG. 3 and described herein).

At operation 806, a score is computed for each of the one or more statements. In some embodiments, operation 806 is performed by a true engine the same as or similar to true engine 320 (shown in FIG. 3 and described herein).

At operation 808, the one or more statements are ranked in a descending order based on the computed scores. In some embodiments, operation 808 is performed by a ranking component the same as or similar to ranking component 316 (shown in FIG. 3 and described herein).

At operation 810, a content card comprising the ranked one or more statements is generated. In some embodiments, operation 810 is performed by a card generating component the same as or similar to card generating component 314 (shown in FIG. 3 and described herein).

At operation 812, the content card is transmitted via a network for presentation on the user device. In some embodiments, operation 812 is performed by a card presenting component the same as or similar to card presenting component 318 (shown in FIG. 3 and described herein).

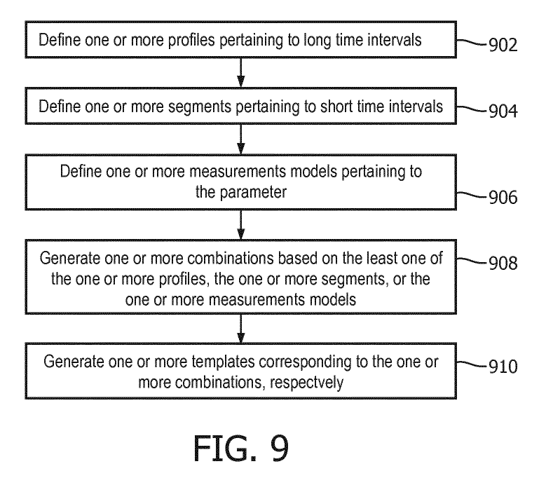

FIG. 9 illustrates an exemplary flowchart for building the templates for generating one or more statements, in accordance with an embodiment of the present teaching. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 9 and described below is not intended to be limiting.

At operation 902, one or more profiles pertaining to long time intervals are defined. In some embodiments, operation 902 is performed by a template building component the same as or similar to template building component 308 (shown in FIG. 3 and described herein).

At operation 904, one or more segments pertaining to short time intervals are defined. In some embodiments, operation 904 is performed by a template building component the same as or similar to template building component 308 (shown in FIG. 3 and described herein).

At operation 906, one or more measurement models pertaining to the parameter are defined. In some embodiments, operation 906 is performed by a template building component the same as or similar to template building component 308 (shown in FIG. 3 and described herein).

At operation 908, one or more combinations based on at least one of the one or more profiles, the one or more segments, or the one or more measurement models are generated. In some embodiments, operation 908 is performed by a template building component the same as or similar to template building component 308 (shown in FIG. 3 and described herein).

At operation 910, one or more templates respectively corresponding to the one or more combinations are generated. In some embodiments, operation 910 is performed by a template building component the same as or similar to template building component 308 (shown in FIG. 3 and described herein).

The above illustrated embodiments configure a system and method for generating one or more statements. However, the present teaching may also be tailored to give data-driven insightful information for caregivers, service providers and policy makers. In some embodiments, profiles of multiple individuals may be combined into population profiles for generating a specific family of statements for population health. For example, in a population health application for municipal health, authorities could contain statements such as “The people of Asian origin in this town typically have lower cholesterol levels than people of Hispanic origin.” The truth engine would compare the profiles of cholesterol values in the Asian and Hispanic communities, and present the statement to the users if the score of the statement indicates high confidence level. In another embodiment, the statements for two or more people can be selected to be aligned in terms of the coaching strategy. For example, for a couple (husband and wife), only statements that are justified by both of their measurements data could be selected. As such, the coaching content delivered to the couple (assuming they live together and can influence each other) is better aligned. In some embodiments, the environmental factors such as location, temperature, humidity, etc., can also be considered while selecting the messages.

Further, the present teaching can be generally used for any application where there is need for extracting insights from large data volumes. In some embodiments, the present teaching may be used for generating insightful statements pertaining to health risks associated with the DNA of an individual or a population. For example, comparing the genes of users to a database associating DNA sequences to health risks may generate a statement like “Based on your genes, you may have increased risk for colon cancer,” or “the population X living in area A have more colon cancer cases than population Y in area B.”

In another embodiment, the present teaching may be used for extracting insights of the work flows, for example, in a hospital. The statement may be generated to convey information such as a certain operation takes more time in the night shift than in the morning shift. In another example, the statement may be generated to convey information such as the number of nurses available for the emergency room (ER) is lower on Tuesdays afternoons than Fridays afternoons.

The present teaching may also be applied beyond the health care domain. In some embodiments, the present teaching may be implemented in a management system for a city street lighting to provide insights about the seasonal power consumption in different city areas or different lighting systems.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system for generating one or more statements, the system comprising:
at least one processor;
memory operatively connected with the at least one processor; and
a communication component operatively connected to the at least one processor and configured to communicate with a user device via a network; wherein the at least one processor is configured by machine-readable instructions to:
receive one or more measurements pertaining to a parameter of a user from the user device;
generate one or more statements based on the one or more measurements and one or more templates; and
transmit, via the network, the one or more statements for presentation on the user device.

2. The system of claim 1, wherein the at least one processor is further configured to:
rank the one or more statements;
generate a content card comprising the ranked one or more statements; and
transmit, via the network, the content card for presentation on the user device.

3. The system of claim 2, wherein the at least one processor is further configured to:
compute a score for each of the one or more statements; and
rank the one or more statements in a descending order based on the computed scores.

4. The system of claim 1, wherein the parameter of the user indicates at least one of physiological signs of the user, psychological signs of the user, or activities of the user.

5. The system of claim 1, wherein the at least one processor is further configured to build the one or more templates pertaining to the parameter, which comprises:
define one or more profiles pertaining to long time intervals;
define one or more segments pertaining to short time intervals;
define one or more measurement models pertaining to the parameter; and
generate one or more combinations based on at least one of the one or more profiles, the one or more segments, or the one or more measurement models, each corresponding to one of the one or more templates.

6. The system of claim 1, wherein the one or more statements convey information of the user and comprise at least one of:
a first comparison description of the one or more measurements between two objects in a temporal space;
a second comparison description of the one or more measurements between two objects in a user space;
an extrema description of the one or more measurements;
an interaction description of the one or more measurement; or
a trend description of the one or more measurements.

7. The system of claim 1, the at least one processor is further configured to:
transmit, via the network, the one or more statements for presentation on the user device in at least a format of text, audio, or video.

8. A method implemented on a system for generating one or more statements, the system comprising at least one processor, memory, and a communication component, the method comprising:
receiving one or more measurements pertaining to a parameter of a user from the user device;
generating one or more statements based on the one or more measurements and one or more templates; and
transmitting, via a network, the one or more statements for presentation on a user device.

9. The method of claim 8, further comprising:
ranking the one or more statements;
generating a content card comprising the ranked one or more statements; and
transmitting, via the network, the content card for presentation on the user device.

10. The method of claim 9, further comprising:
computing a score for each of the one or more statements; and
ranking the one or more statements in a descending order based on the computed scores.

11. The method of claim 8, the parameter of the user indicates at least one of physiological signs of the user, psychological signs of the user, or activities of the user.

12. The method of claim 8, further comprising:
defining one or more profiles pertaining to long time intervals;
defining one or more segments pertaining to short time intervals;
defining one or more measurement models pertaining to the parameter; and
generating one or more combinations based on at least one of the one or more profiles, the one or more segments, or the one or more measurement models, each corresponding to one of the one or more templates.

13. The method of claim 8, wherein the one or more statements convey information of the user and comprise at least one of:
a first comparison description of the one or more measurements between two objects in a temporal space;
a second comparison description of the one or more measurements between two objects in a user space;
an extrema description of the one or more measurements;
an interaction description of the one or more measurement; or
a trend description of the one or more measurements.

14. The method of claim 8, further comprising:
transmitting, via the network, the one or more statements for presentation on the user device in at least a format of text, audio, or video.

15. A system for generating one or more statements, the system comprising:
means for receiving, with at least one processor, one or more measurements pertaining to a parameter of a user from the user device;
means for generating, with at least one processor, one or more statements based on the one or more measurements and one or more templates; and
means for transmitting, with at least one processor, the one or more statements for presentation on a user device via a network.

16. The system of claim 15, further comprising:
means for ranking the one or more statements;
means for generating a content card comprising the ranked one or more statements; and
means for transmitting, via the network, the content card for presentation on the user device.

17. The system of claim 16, further comprising:
means for computing a score for each of the one or more statements; and
means for ranking the one or more statements in a descending order based on the computed scores.

18. The system of claim 15, wherein the parameter of the user indicates at least one of physiological signs of the user, psychological signs of the user, or activities of the user.

19. The system of claim 15, further comprising:
means for defining one or more profiles pertaining to long time intervals;
means for defining one or more segments pertaining to short time intervals;
means for defining one or more measurement models pertaining to the parameter; and
means for generating one or more combinations based on at least one of the one or more profiles, the one or more segments, or the one or more measurement models, each corresponding to one of the one or more templates.

20. The system of claim 15, wherein the one or more statements convey information of the user and comprise at least one of:
a first comparison description of the one or more measurements between two objects in a temporal space;
a second comparison description of the one or more measurements between two objects in a user space;
an extrema description of the one or more measurements;
an interaction description of the one or more measurement; or
a trend description of the one or more measurements.
